(19) United States
(12) Patent Application Publication
(10) Pub. No.: US 2019/0392796 A1
(43) Pub. Date: Dec. 26, 2019

(54) INSTRUMENT SUPPORT

(71) Applicant: Tatsuro MIYATAKE, Fuchu-shi (JP)

(72) Inventor: Tatsuro MIYATAKE, Fuchu-shi (JP)

(21) Appl. No.: 16/018,554

(22) Filed: Jun. 26, 2018

(51) Int. Cl. G10G 5/00

(52) U.S. Cl. CPC G10G 5/005; G10D 7/08

(57) ABSTRACT

An instrument support includes a first elongated member, a second elongated member, and a bridge that connects the first elongated member to the second elongated member. The relative orientation of the first elongated member with respect to the bridge is fixed, and the relative orientation of the second elongated member with respect to the bridge is fixed.

### BACKGROUND

The present disclosure relates to supports for maintaining an orientation of an instrument with respect to the body of a user. Related technical fields include body supports, straps, attachments for musical instruments, and more specifically, body straps for hanging a saxophone or similar musical instrument from a user's body.

Various musical instruments require the performing musician, i.e. the user, to hold or carry the instrument as the instrument is being played. Instrument supports assist the user in holding or carrying an instrument when the instrument is being played or even when the instrument is not being played.

Depending on the position of the instrument with respect to the user's body when the instrument is played, the instrument support is designed to distribute the weight of the instrument on the body of the user. For example, an instrument support that hangs an instrument, such as a guitar, that is to be played on the side of the user may be designed to distribute the weight of the instrument in such a manner that performing of the instrument on the side of the user is facilitated. Likewise, an instrument, such as a saxophone, that is played in front of the user may be designed to distribute the weight of the instrument in such a manner that performing of the instrument on the front of the user is facilitated.

With regard to saxophone supports, went distribution of the saxophone along the shoulders and neck portion of the user is critical because inadequate weight distribution may lead to discomfort of the user. Saxophone supports vary in design and weight distribution of the saxophone upon the body of the user. Some saxophone support designs unevenly distribute the weight of the saxophone on the neck of a user, thereby contributing to neck strain. Alternative saxophone support designs distribute the weight of the saxophone on the shoulders of a user. However, due to natural movements of the instrument by the user during performance and/or regular use, the alternative designs are susceptible to undesired repositioning on the shoulders, thereby leading to uneven weight distribution on the shoulders of the user and contributing to user discomfort.

### SUMMARY

In an exemplary embodiment, an instrument support includes a first elongated member, a second elongated member, and a bridge that connects the first elongated member to the second elongated member. The bridge is integrally formed with each of the first elongated member and the second elongated member. Accordingly, the first elongated member is substantially fixed with relation to the bridge and the second elongated member is substantially fixed with relation to the bridge. Likewise, the relative orientation of the first elongated member with respect to the bridge is substantially fixed, and the relative orientation of the second elongated member with respect to the bridge is substantially fixed.

The instrument support is to be placed on a user's shoulders whereby each elongated member curves around a corresponding shoulder of the user. The bridge contours around the rear-base of the user's neck, extending from one shoulder to the other shoulder.

When the instrument support is worn by the user and an instrument is attached to the instrument support, the weight of the instrument is broadly distributed over the upper body of the user. Specifically, the elongated members distribute a portion of the weight of the attached instrument over the shoulders and the portions of the user's body adjacent to the shoulders that are in contact with the instrument support. In addition, the bridge support distributes a remaining portion of the weight of the attached instrument around the base of the user's neck.

The arrangement of the elongated members and bridge minimize the load of the instrument on the neck and securely distributes the weight of the instrument upon the upper body of the user. Furthermore, the instrument support maintains the orientation of the instrument with respect to the body of a user.

### BRIEF DESCRIPTION OF THE DRAWINGS

Exemplary embodiments can be described with reference to the following figures wherein:

FIG. 1 illustrates a top-front view of an exemplary instrument support.

FIG. 2 illustrates a front view of the exemplary instrument support.

FIG. 3 illustrates a top view of the exemplary instrument support.

FIG. 4 illustrates a side view of the exemplary instrument support.

FIG. 5 illustrates a rear view of the exemplary instrument support.

FIG. 6 illustrates a perspective view of the exemplary instrument support.

FIG. 7 illustrates a user wearing an instrument support with the instrument attachment mechanism and an attached instrument.

FIG. 8 illustrates a cross-section view of the elongated member of the instrument support along line 8 in FIG. 3.

FIG. 9 illustrates a cross-section view of a bridge of the instrument support along line 9 in FIG. 3.

FIG. 10 illustrates a top view of a connection of the instrument support.

FIG. 11 illustrates a cross-section view of the connection of the instrument support along line 11 in FIG. 10.

FIG. 12 illustrates a top view of a stabilizer.

FIG. 13 illustrates a rear view of the stabilizer.

FIG. 14 illustrates a front view of an exemplary dismountable instrument support.

FIG. 15 illustrates a top view of the exemplary dismountable instrument support.

FIG. 16 illustrates a top view of bridge of the exemplary dismountable instrument support.

FIG. 17 illustrates a cross-section view of a bridge of the instrument support along line 17 in FIG. 16.

FIG. 18 illustrates a top view of an exemplary extendable instrument support.

FIG. 19 illustrates a cross section view of an alternative connection of the instrument support.

FIG. 20 illustrates a perspective view of an exemplary instrument support with a securing mechanism.

### DETAILED DESCRIPTION OF EMBODIMENTS

In one embodiment, the instrument support has a bridge that is integrally formed with each of a first elongated member and a second elongated member.

The instrument support is configured to rest on the shoulders of a user and evenly distribute the weight of an instrument across the upper torso of the user. Two elongated members, i.e. a first elongated member and a second elongated member, are configured to sit on the shoulders of the user and curve with the curvature of the user's shoulders. A bridge connects the first elongated member to the second elongated member and is integrally formed with each one of the elongated members. As such, the relative orientation between the first elongated member and the bridge is substantially fixed. Likewise, the relative orientation between the second elongated member and the bridge is substantially fixed. By keeping the relative orientation of each elongated member and the bridge substantially fixed, the elongated members remain securely in place despite natural instrument movements that may occur during performance or normal playing of the instrument by the user.

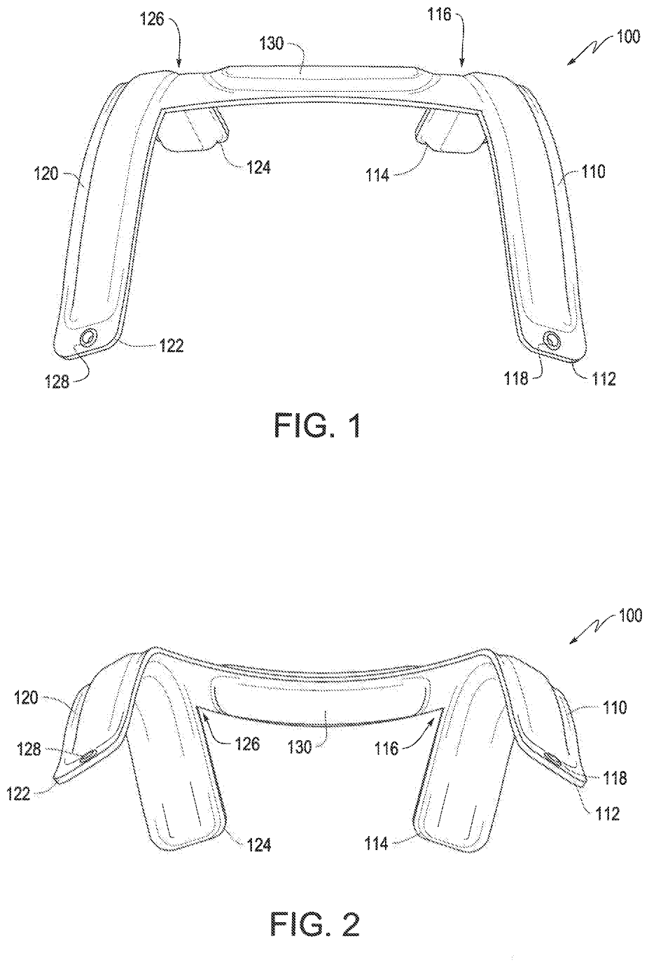

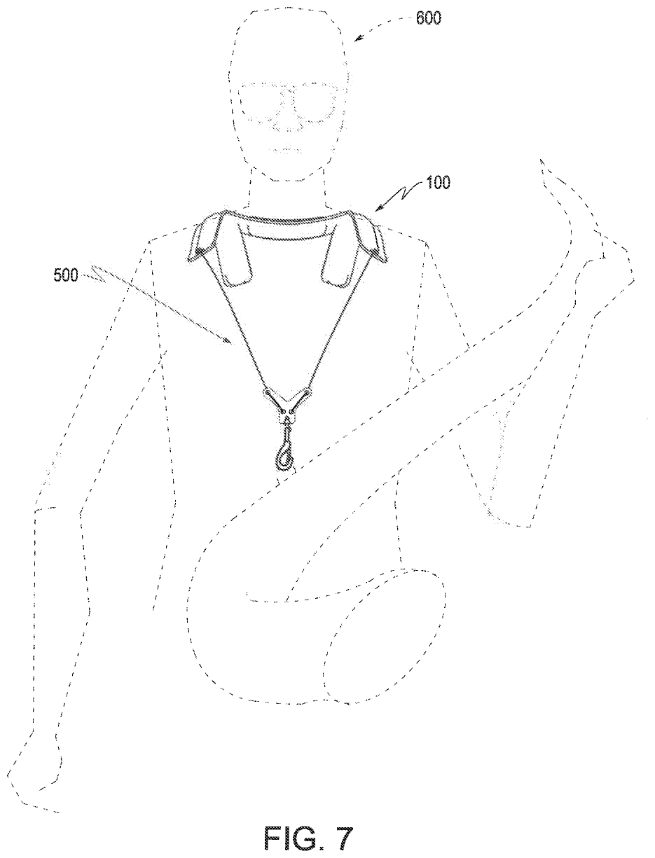

In FIGS. 1 and 2, the exemplary instrument support 100 is depicted in a top-front view and a front view, respectively. The instrument support 100 includes a first elongated member 110, a second elongated member 120, and a bridge 130 that connects the first elongated member 110 to the second elongated member 120. The first elongated member 110 and second elongated member 120 are curved with a concavity at the bottom of the instrument support 100. The curvatures of each of the first elongated member 110 and second elongated member 120 allow the first and second elongated members 110, 120 to rest on the shoulders of a user 600 wearing the instrument support 100 (see FIG. 7).

The first and second elongated members 110, 120 each have two ends. The first elongated member 110 has a first end 112 at the front of the instrument support 100 and a second end 114 at the rear of the instrument support 100. The second elongated member 120 has a first end 122 at the front of the instrument support 100 and a second end 124 at the rear of the instrument support 100. Attachment portions 118, 128, configured to receive an instrument attachment mechanism 500 (as shown in FIG. 7), are located at the front ends 112, 122 of the first and second elongated members 110, 120. In the embodiment depicted in FIGS. 1 and 2, the attachment portions 118, 128 are rings formed into the elongated members wherein a string or a set of strings, as part of the instrument attachment mechanism 500, may be inserted and tied to the attachment portions 118, 128 so as to be affixed to the first and second elongated members 110, 120. In this configuration, the string or set of strings are components of the instrument attachment mechanism 500 and connect the instrument attachment mechanism 500 to the instrument support 100. Of course, this is only one from the instrument attachment mechanism 500 can take, and the attachment portions may be configured to receive a variety of instrument attachment mechanisms 500.

The bridge 130 may be integrally formed with each of the first and second elongated members 110, 120. Specifically, the first elongated member 110 is in communication with the bridge 130 via a connection 116. Likewise, on the opposite side of the bridge 130, the second elongated member 120 is in communication with the bridge 130 via a connection 126. Accordingly, the first elongated member 110 is substantially fixed with relation to the bridge 130 and the second elongated member 120 is substantially fixed with relation to the bridge 130. The bridge is adjacent to center points between the first ends 112, 122 and the second ends 114, 124 of each of the respective first and second elongated members 110, 120. In addition, the relative orientation of the first elongated member 110 with respect to the bridge 130 is substantially fixed by the connection 116, and the relative orientation of the second elongated member 120 with respect to the bridge 130 is substantially fixed by the connection 126.

“Substantially fixed,” as used herein, is made in reference to a restriction of the movement of a component with respect to another component. For purposes of this disclosure, two components are “substantially fixed” if the components cannot move more than 20 degrees in rotation in any plane with respect to each other. In addition, two components that are “substantially fixed” cannot move in translation more than 2 centimeters with respect to each other in any plane. Thus, components that are substantially fixed in relative orientation, or with respect to each other, are limited in respective degrees of freedom in both rotational movement and translational movement.

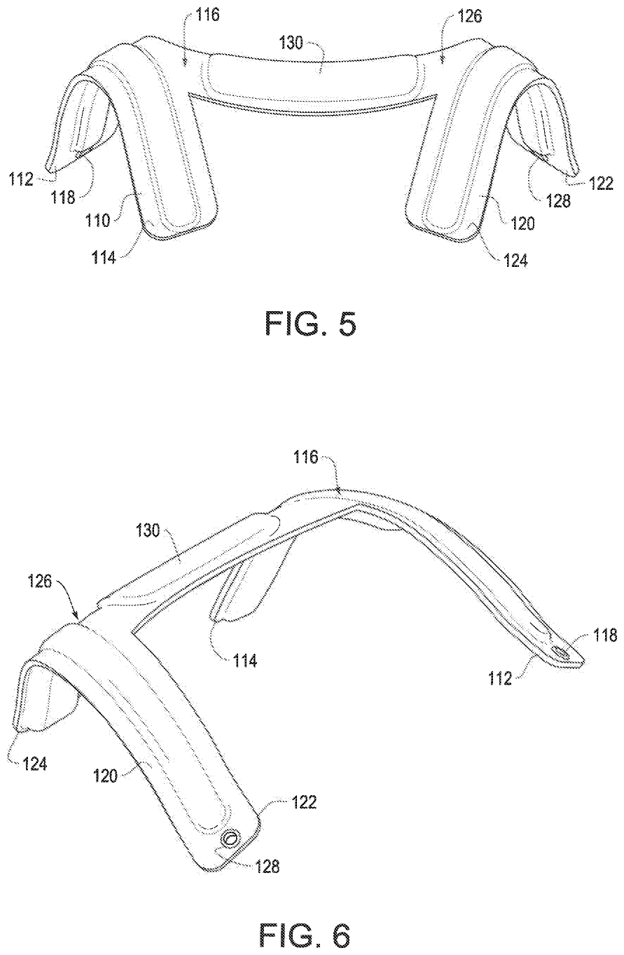

As shown in FIGS. 2-7, the first and second elongated members 110, 120 may extend further towards the rear of the instrument support 100 than towards the front of the instrument support 100. An exemplary positioning of the instrument support 100 on a user 600 is depicted in FIG. 7. With the first and second elongated members 110, 120 extending further towards the rear of the instrument support 100, the instrument support 100 is configured to sit on the shoulders of the user 600 wearing the instrument support 100 in such a way that the instrument support 100 is in contact with the shoulder blades of the user 600 wearing the instrument support 100. By being in contact with the shoulder blades of the user 600, the instrument support 100 has leverage over the upper back of the user 600 and may disperse the weight of an attached instrument across a larger area of the upper back of the user 600 wearing the instrument support 100. In addition, the bridge 130 is disposed towards the rear of the instrument support 100. The positioning and angle of the bridge 1.30 allows the bridge to sit on the rear base of a user's 600 neck.

A cushion layer 144, 134 is disposed in various locations within the instrument support 100 in order to provide padding Where the instrument support 100 contacts the body of the user 600 that is wearing the instrument support 100. In one embodiment, the cushion layer 144 may be thicker towards the rear of the elongated members 110, 120 than towards the front of the elongated members. This allows for particular locating of the padding where the weight of the instrument is to be most heavily transferred on the upper body of the user 600 wearing the instrument support 100.

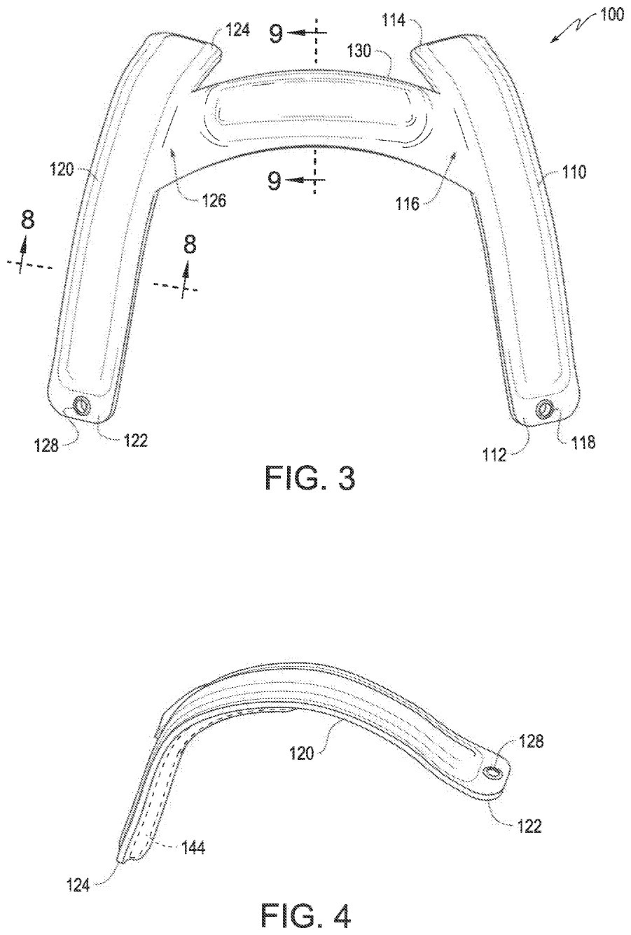

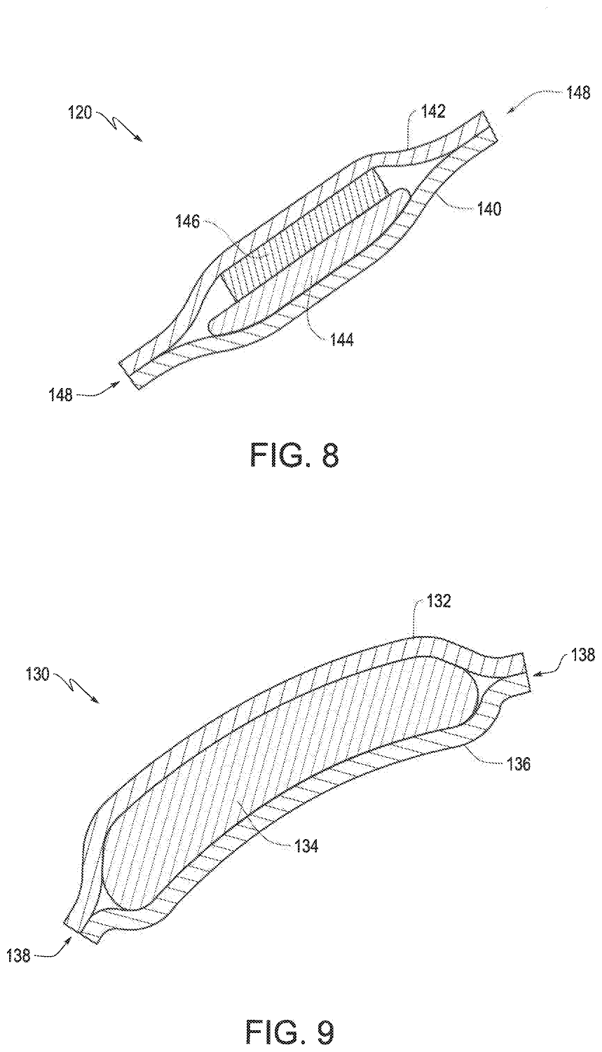

In regard to FIG. 8, a cross section along line 8 in FIG. 3 of the elongated member 120 is depicted. As discussed above, the first and second elongated members 110, 120 each extend from a first end 112, 122 to a second end 114, 124, respectively. Each elongated member has a first outer layer 140 and a second outer layer 142, and within each elongated member is a bar 146 that extends from approximately the first end 112, 122 to approximately the second end 114, 124 of each elongated member. The bar 146 is rigid and maintains the curved form of the elongated member. The bar 146 is made of a rigid material including, but not limited to, aluminum, steel, copper, iron, plastic, acrylic, carbon fiber, and wood. Adjacent the bar is a cushion layer 144 that provides comfort to the user 600 wearing the instrument support 100 by cushioning the weight transferred from the instrument support 100 to the body of the user 600. For example, as shown in FIG. 8, the cushion layer 144 may be positioned between the bar 146 and the first outer layer 140 so as to retain a cushioning effect of the cushion layer 144 on the body of the user 600 while minimizing the use of excess material. Alternatively, another cushion layer may be placed on the opposite side of the bar 146 from the cushion layer 144, i.e. between the bar 146 and the second outer layer 142, so as to provide, together with the cushion layer 144, cushioning on both sides of the second elongated member 120. The first outer layer 140 and the second outer layer 142 are affixed to each other on outer edges 148 of each of the elongated members. The first outer layer 140 and the second outer layer 142 may be affixed to each other by glue, stitches, sewing, staples, rivets, or any other suitable means of affixation. The outer layers of the instrument support, including the first outer layers 140, 136 and the second outer layers 142, 132 of the elongated members 110, 120 and the bridge 130, respectively, are made of materials including, but not limited to, leather, faux leather, polyester, cotton, cloth, nylon, and vinyl plastic.

With regard to FIG. 9, a cross section of the bridge 130 taken along line 9 of FIG. 3 is depicted. The bridge 130 may be formed by a cushion layer 134 sandwiched by a first outer layer 136 and a second outer layer 132. The lack of a bar within the bridge 130 allows for the bridge 130 to comfortably form around the rear base of the neck of the user 600. Similar to the outer layers of the elongated members, the first outer layer 136 and second outer layer 132 are affixed to each other on outer edges 138 of the bridge 130, and the outer layers may be affixed to each other by glue, stitches, sewing, staples, rivets, or any other suitable means of affixation. Although the bridge 130 is depicted in FIG. 9 with a cushion layer 134, the bridge 130 may also be formed without a cushion layer. In this configuration, there would be no layer disposed between the first outer layer 136 and the second outer layer 132.

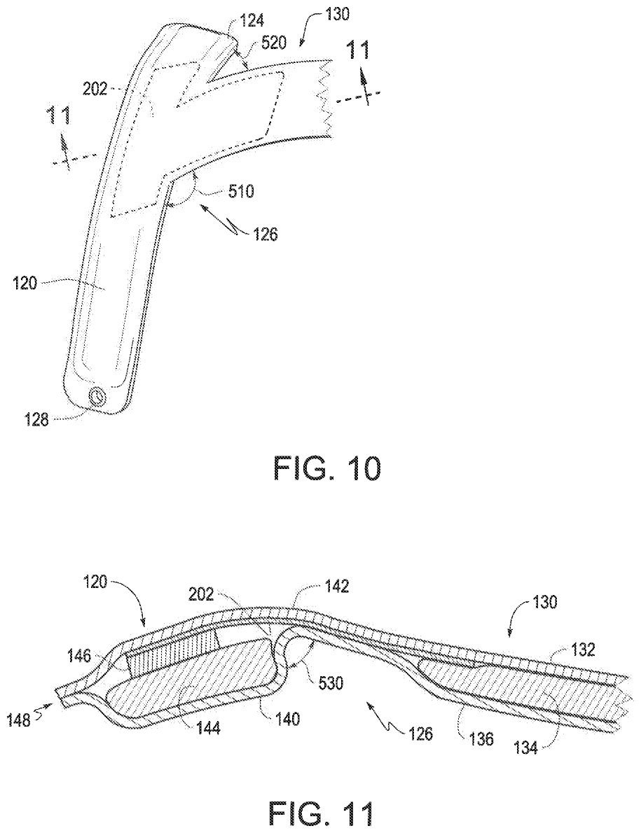

With respect to FIG. 10, a portion of the instrument support 100 is depicted where the bridge 130 integrally connects with the second elongated member 120. The instrument support 100 is symmetrical across the bridge 130, and thus the portion of the instrument support 100 with the first elongated member 110 is a mirror image of the portion with the second elongated member 120, as shown in FIG. 10. In one embodiment, the bridge 130 is connected to each one of the first elongated member 110 and the second elongated member 120. At the connection 116, 126 between the bridge 130 and elongated members 110, 120, respectively, a rigid stabilizer is embedded between the first outer layer 140 and the second outer layer 142. A first stabilizer 200 extends from the bridge 130 and across the connection 116 to the first elongated member 110. A second stabilizer 202 extends from the bridge 130 and across the connection 126 to the second elongated member 120. Each of the first and second stabilizers 200, 202 is formed of a one-piece integrally formed rigid material whose rigidity is greater than that of the first and second outer layers 140, 142 of the first and second elongated members H 0, 120, as well as that of the first and second outer layers 136, 132 of the bridge 130. The rigidity of the first and second stabilizers 200, 202 maintains the orientation of the respective first and second elongated members 110, 120 substantially fixed with respect to the bridge 130. For example, the second stabilizer 202 maintains the angle 510 between the first end 122 of the second elongated member 120 and the bridge 130 substantially fixed. The second stabilizer 202 also maintains the angle 520 between the second end 124 of the second elongated member 120 and the bridge 130 substantially fixed. The first stabilizer 200 performs the same function as the second stabilizer 202, but on the opposite side of the instrument support 100. The stabilizers 200, 202 may be made of any rigid material including, but not limited to, aluminum, steel, copper, iron, plastic, acrylic, carbon fiber, and wood. The stabilizers 200 may also be made of semi-rigid materials, such as ethylene-vinyl acetate (EVA), which are rigid enough to keep the relative orientations of the elongated members with respect to the bridge fixed, but soft enough to provide comfort to the user wearing the instrument support.

FIG. 11 illustrates a cross section view of the integrated connection 126 between the second elongated member 120 and the bridge 130. As shown in FIG. 11, the second stabilizer 202 extends across the connection 126 between the second elongated member 120 and the bridge 130. Within the second elongated member 120, the second stabilizer 202 is interposed between the second outer layer 142 and the cushion layer 144. The second stabilizer 202 sits between the bar 146 and the second outer layer 142. Within the connection 126, the second stabilizer 202 is positioned between the first outer layer 140 and the second outer layer 142. Within the bridge 130, the second stabilizer 202 is positioned between the cushion layer 134 and the second outer layer 132. Because the second stabilizer 202 is rigid, the contour of the connection 126 is maintained as well as the relative orientation between the second elongated member 120 and the bridge 130. Alternatively, if the second elongated member has a cushion layer on both sides of the bar 146, the second stabilizer 202 may be disposed between the second outer layer 142 and the cushion layer opposite of the bar 146 from the cushion layer 144. The rigidity of the first and second stabilizers 200, 202 maintains the orientation of the respective first and second elongated members 110, 120 substantially fixed with respect to the bridge 130 in all three dimensions. For example, as described above in reference to FIG. 10, the second stabilizer maintains the angles 510 and 520 substantially fixed. The second stabilizer 202 additionally maintains the angle 530, as shown in FIG. 11, between the second elongated member 120 and the bridge 130 substantially fixed.

The first stabilizer 200, which extends from the bridge 130 and across the connection 116 to the first elongated member 110, is similarly positioned within the first elongated member 110 and the bridge 130 as the second stabilizer 202 is positioned with respect to the second elongated member 120 and the bridge 130. Similarly to the second stabilizer 202, the first stabilizer 200 maintains the angle between the first elongated member 110 and the bridge 130 on the opposite side of the instrument support 100.

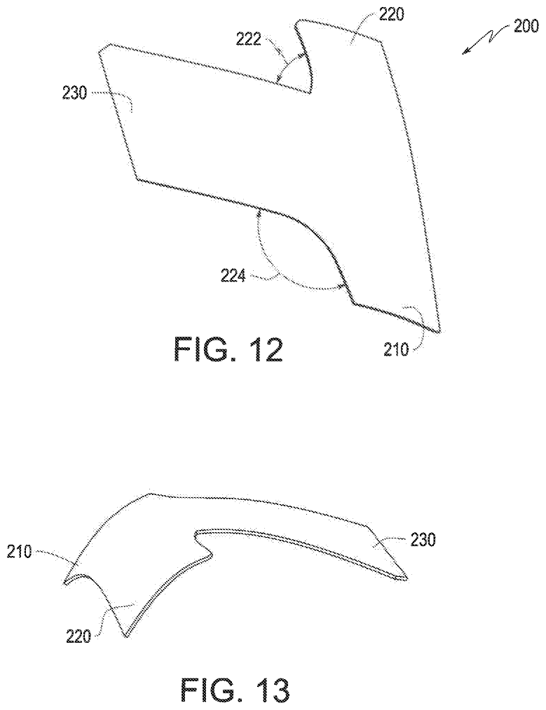

With respect to FIGS. 12 and 13, the first stabilizer 200 is depicted in a top view and a rear view, respectively. The first stabilizer 200 has a front extension 210 and a rear extension 220 which extend towards the respective first end 112 and second end 114 of the first elongated member 110. A side extension 230 of the first stabilizer 200 extends towards the center of the bridge 130. The first stabilizer 200 is curved in a form that follows the contours of the first elongated member 110 and of the left shoulder of the user 600. Although the second stabilizer 202 is curved in a similar manner as the first stabilizer 200, the configuration and curvature of the second stabilizer is in the opposite form so as to contour the right shoulder of the user 600. Although a mirror image of the second stabilizer 202 is not shown, the second stabilizer 202 includes the same features as the first stabilizer 200, but in the opposite orientation.

The first stabilizer 200 and the second stabilizer 202 maintain the orientation of the first elongated member 110 and the second elongated member 120 with respect to the bridge 130. Accordingly, the first and second elongated members 110, 120 do not rotate with respect to the bridge 130. In addition, the first and second elongated members 110, 120 do not change the relative angle made with respect to the bridge 130 at the connections 116, 126, respectively. The angle 222 indicated in FIG. 12, formed between the rear extension 220 and the side extension 230 is maintained by the rigidity of the stabilizer 200 such that the angle and orientation made between the elongated member 110 and the bridge 130 is maintained. Likewise, the angle 224, which is formed between the front extension 210 and the side extension 230, is also maintained by the rigidity of the stabilizer 200. Twisting and bending of the instrument support 100 is therefore inhibited by the positioning of the stabilizers 200, 202 within the instrument support 100.

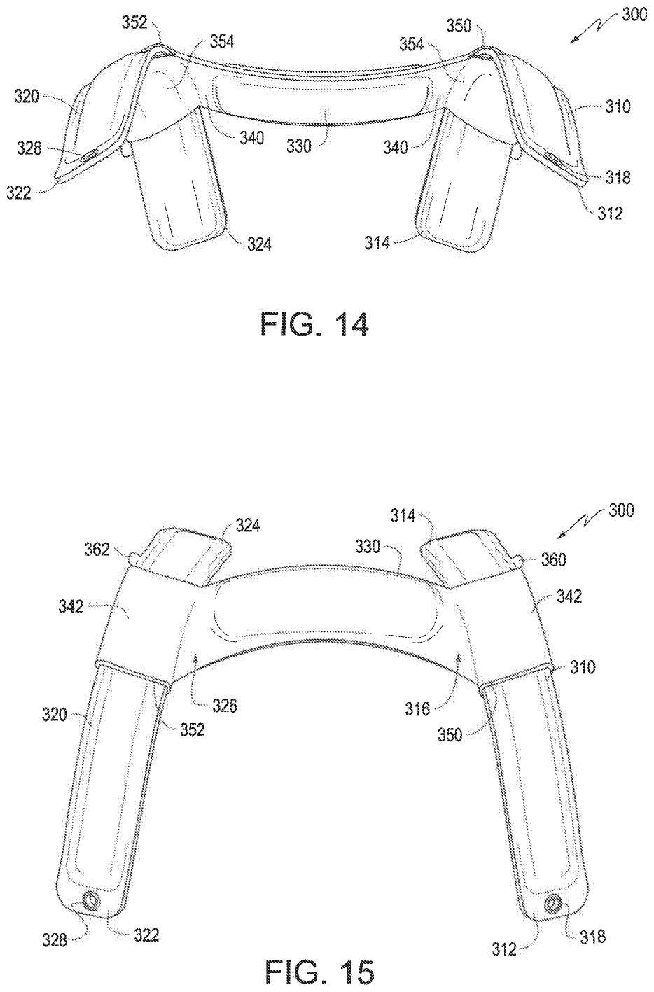

In another embodiment, an instrument support is configured for disassembly. In other words, the first elongated member, the second elongated member, and the bridge are separately formed members. As depicted in FIGS. 14 and 15, an instrument support 300 is depicted in a front view and a top view, respectively. The instrument support 300 includes a first elongated member 310, a second elongated member 320, and a bridge 330 that connects to the first elongated member 310 and the second elongated member 320. The first elongated member 310 and the second elongated member 320 are curved with a concavity at the bottom of the instrument support 300. The curvatures of each of the first elongated member 310 and second elongated member 320 allow the first and second elongated members 310, 320 to rest on the shoulders of the user 600 wearing the instrument support 300.

Similarly to other embodiments, the first and second elongated members 310, 320 each have two ends. The first elongated member 310 has a first end 312 at the front of the instrument support 300 and a second end 314 at the rear of the instrument support 300. The second elongated member 32.0 has a first end 322 at the front of the instrument support 300 and a second end 324 at the rear of the instrument support 300. Attachment portions 318, 328, configured to receive an instrument attachment such as the instrument attachment mechanism 500, are located at the front ends 312, 322 of the first and second elongated members 310, 320.

The bridge 330 includes a first slot 350 and a second slot 352, each slot formed by a third layer 354 that encloses a first outer layer 340 of the bridge 330. The first and second slots 350, 352 of the bridge 330 open in elongated directions of the respective first and second elongated members 310, 320. For assembly, the first elongated member 310 slides lengthwise into the slot 350 of the bridge 330 at the connection 316. The first elongated member 310 has a protrusion 360 that stops the first elongated member 310 from sliding completely through the slot 350. Likewise, on the opposite side of the bridge 330, the second elongated member 320 slides lengthwise into the second slot 352 of the bridge 330 at the connection 326. The second elongated member 320 has a protrusion 362 that stops the second elongated member 320 from sliding completely through the second slot 352. The protrusions 360, 362 are positioned at points along the lengths of the first and second elongated members 310, 320, respectively, and abut the bridge 330 when the first and second elongated members 310, 320 are assembled with the bridge. Accordingly, upon assembly of the first and second elongated members 310, 320 with the bridge 330, the first elongated member 310 is substantially fixed in relation to the bridge 330, the second elongated member 320 is substantially fixed in relation to the bridge 330, and the bridge 330 is adjacent to center points between the first ends 312, 322 and the second ends 314, 324 of each of the respective first and second elongated members 310, 320. In addition, the relative orientation of the first elongated member 310 with respect to the bridge 330 is substantially fixed, and the relative orientation of the second elongated member 320 with respect to the bridge 330 is substantially fixed.

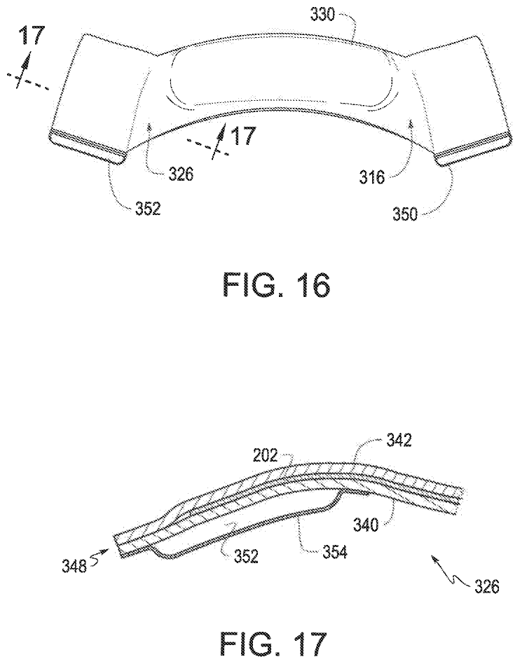

As depicted in FIG. 16, the bridge 330 includes the connections 316, 326. The first slot 350 and the second slot 352 extend from connections 316 and 326, respectively. With regard to FIG. 17, a cross section of the bridge 330 along line 17 of FIG. 16 is depicted. As shown in FIG. 17, the second slot 352 is formed by the third layer 354 and the first outer layer 340. A third layer 354 is provided so as to cover the first outer layer 340, the second slot 352 being defined between the third layer 354 and the first outer layer 340. The stabilizer 202 is disposed between the first outer layer 340 and the second outer layer 342 and extends over the second slot 352. The orientation of the second slot 352 with respect to the bridge 330 is maintained by the rigid stabilizer 202. As a result, upon assembly, the orientation of the elongated members 310, 320 with respect to the bridge 330 is maintained.

The instrument support 300 is symmetrical across the bridge 330, and thus the portion of the instrument support 300 with the first slot 350 is a mirror image of the portion with the second slot 352, as shown in FIG. 17. Accordingly, the first stabilizer 200, which extends from the bridge 330 and across the connection 316 over the first slot 350, is positioned between the first outer layer 340 and the second outer layer 342, similar to the second stabilizer 202 depicted in FIG. 17.

With respect to the instrument support 100 depicted in FIGS. 1-6 and 18, the angle formed between the elongated members 110, 120 and the bridge 130 may vary. For example, the elongated members 110, 120 may be angled perpendicularly to the bridge 130. Alternatively, the elongated members 110, 120 may have an angle that is larger towards the front of the instrument support 100 and smaller towards the rear of the instrument support 100.

With respect to the instrument support 300 depicted in FIGS. 14-17, the angle formed between the first and second slots 350, 352 and the bridge 330 may vary such that when the elongated members 310, 320 are assembled, the desired angle between each elongated member 310, 320 and the bridge 330 is achieved. For example, the first and second slots 350, 352 may be configured such that the elongated members 310, 320 are angled perpendicularly to the bridge 330. Alternatively, the first and second slots 350, 352 may be configured such that the elongated members 310, 320 have an angle that is larger towards the front of the instrument support 300 and smaller towards the rear of the instrument support 300.

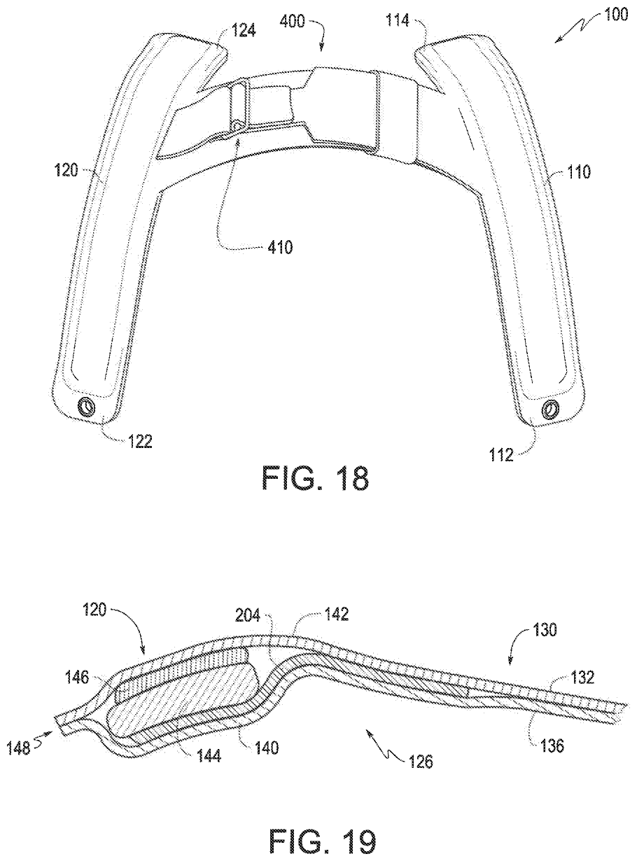

In another embodiment, the bridge may include an extension mechanism 400, as shown in FIG. 18. The extension mechanism 400 is configured to vary a distance between the first elongated member 110 and the second elongated member 120. As depicted in FIG. 18, the extension mechanism 400 may be in the form of a buckle 410 that allows the user 600 to vary the length of the bridge. Alternatively, the extension mechanism 400 may be in the form of a hook and loop fastener that is attachable and detachable to vary the length of the bridge. Stabilizers (not shown) may be disposed within the instrument support 100 in a similar manner as described above with respect to FIGS. 10 and 11 Although the length may be changed, the relative orientation between the first elongated member 110 and the bridge and the relative orientation between the second elongated member 120 and the bridge remain substantially fixed. As in the earlier described embodiments, the stabilizers maintain the orientation of the elongated members 110, 120 with respect to the bridge 130.

In yet another embodiment, the bridge may exclude the cushion layer, as shown in FIG. 19. Similarly to FIG. 11, FIG. 19 illustrates a cross section view of the integrated connection 126 between the second elongated member 120 and the bridge 130. The second stabilizer 204 extends across the connection 126 between the second elongated member 120 and the bridge 130. Within the second elongated member 120, the second stabilizer 204 is interposed between the first outer layer 140 and the cushion layer 144. The first outer layer 140 and the second outer layer 142 are affixed to each other on outer edges 148 of each of the elongated members. Within the connection 126, the second stabilizer 204 is positioned between the first outer layer 140 and the second outer layer 142. The second stabilizer 204 extends partially inside the bridge 130 toward a center of the bridge 130. The center of the bridge 130 may be formed of only the first outer layer 136 and the second outer layer 132, with the first and second outer layers 136, 132 being affixed to each other. The second stabilizer 204 maintains the shape of the connection 126 as well as the relative orientation between the second elongated member 120 and the bridge 130. The first stabilizer (not shown) is similarly positioned as the second stabilizer 204, but on the opposite side of the instrument support. The stabilizer 204, as shown in FIG. 19, may be made of a semi-rigid material, e.g., EVA, and allows for only minimal relative movement between the second elongated member 120 and the bridge 130 at the connection 126. Of course, the stabilizer 204 may be made of more rigid materials, such as the materials used for the first and second stabilizers 200 and 204, as described above in other embodiments.

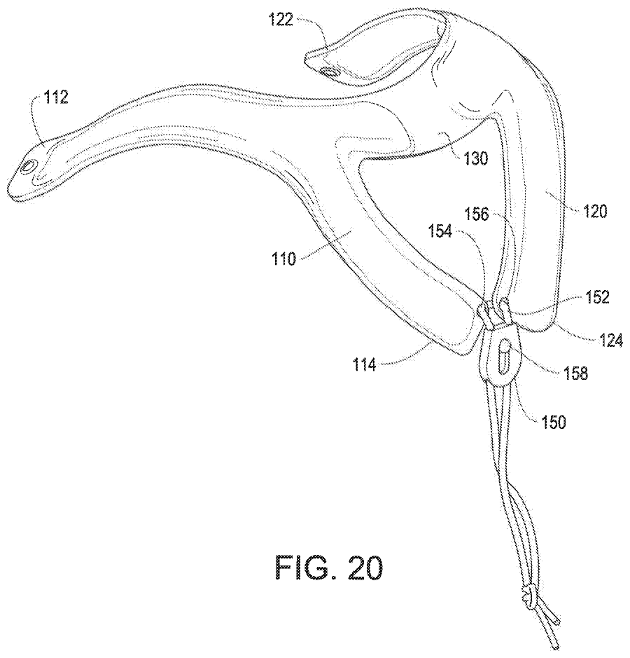

In a further embodiment of the instrument support 100, the second ends 114, 124 of the first elongated member 110 and second elongated member 120, respectively, are secured together by a securing mechanism 150, as illustrated in FIG. 20. The securing mechanism 150 may be a mechanism that ties, hooks, or otherwise fastens the second ends 114, 124 together. In the embodiment depicted in FIG. 20, the securing mechanism 150 has a cord 152 that passes through holes 154, 156 in the first elongated member 110 and second elongated member 120, respectively. The cord 152 passes through the securing mechanism 150 and is either locked in position or unlocked by a locking part 158. By locking the cord 152 with the locking part 158, the securing mechanism 150 secures the first and second elongated members 110, 120 in a secured position where the second ends 114, 124 are closer together and the first ends 112, 122 are farther apart. In the secured position, the relative positions of the elongated members 110, 120 allow the instrument support 100 to shift the distribution of weight on the user to the elongated members 110, 120 and away from the bridge 130. In an unsecured position, the cord 152 is released thereby allowing for the second ends 114, 124 of the elongated members 110, 120 to move farther apart and the first ends 112, 122 to come closer. In the unsecured position, the less restricted movement of the second ends 114, 124 of the elongated members 110, 120 allows for the instrument support 100 to be folded for storage or transport. It should be understood that the securing mechanism 150 may take a variety of forms other than the cord stopper shown in FIG. 20, such as a hook or any such suitable securing mechanism configured to secure the second ends 114, 124 using the holes 154, 156.

The dimensions of the instrument support 100 may vary, but one embodiment may have the following approximate dimensions. The bridge may be in the range of 4 to 8 inches (e.g., 6 inches) in length (from the connection 116 to the connection 126), may be in the range of 1 to 3 inches (e.g., 1.75 inches) in width (from a front side of the bridge to a rear side of the bridge), and may be in the range of 0.1 to 1 inches (e.g., 0.4 inches) in thickness (from the first outer layer 136 to the second outer layer 132). Each elongated member may be in the range of 6 to 12 inches (e.g., 8.5 inches) in length (from the first end 112, 122 to the second end 114,124 of the respective elongated member and along the curvature of the elongated member), may have a width in the range of 1 to 3 inches (e.g., 1.5 inches), and may have a thickness in the range of 0.1 to 1 inch (e.g., 0.5 inches) (from the first outer layer 140 to the second outer layer 142 and at a point with the thickest cushion layer 144). The angle 510 between the first end 122 of the second elongated member 120 and the bridge 130 may be in the range of 90 to 150 degrees (e.g., 135 degrees). The angle 520 between the second end 124 of the second elongated member 120 and the bridge 130 may be in the range of 35 to 60 degrees (e.g., 45 degrees). The curvature of the elongated members 110, 120 may have an arc radius in the range of 2 to 4 inches (e.g., 3 inches). The stabilizers may have a thickness in the range of 0.02 to 0.3 inches (e.g., 0.1 inches). The instrument support 300 may have similar dimensions as the instrument support 100. The abovementioned dimensions are approximations and may vary based on sizing for different size persons or types of instrument to be attached.

The embodiments disclosed herein provide an instrument support that distributes the weight of the attached instrument along the upper body of the user. The instrument support maintains the respective orientation of its subparts so that the weight of the attached instrument is evenly distributed along the upper body of the user, and the even distribution is maintained despite movements of the user. During the intended movement of an attached instrument to the instrument support, e a saxophone, movement of the instrument support on the user's body is expected. However, by maintaining the relative orientations of the elongated members and the bridge substantially fixed, the instrument support does not vary the positioning of the elongated members and the bridge, thereby attaining consistent distribution of the instrument's weight.

While various features have been described in conjunction with the examples outlined above, various alternatives, modifications, variations, and/or improvements of those features and/or examples may be possible. Accordingly, the examples, as set forth above, are intended to be illustrative. Various changes may be made without departing from the broad spirit and scope of the underlying inventive principles.

What is claimed is

1. An instrument support comprising:
first and second elongated members; and
a bridge connecting the first elongated member to the second elongated member, the bridge being integrally formed with each of the first and second elongated members such that a relative orientation between each of the first and second elongated members with respect to the bridge is substantially fixed.

2. The instrument support of claim 1, wherein each of the first and second elongated members has a first end and a second end defining a length of each of the first and second elongated members, and each of the first and second elongated members is curved between the first and second ends.

3. The instrument support of claim 1, wherein each of the first and second elongated members includes:
a first outer layer;
a second outer layer; and
a cushion layer interposed between the first and second outer layers.

4. The instrument support of claim 3, further comprising first and second stabilizers, the first stabilizer being positioned at a connection between the bridge and the first elongated member, the second stabilizer being positioned at a connection between the bridge and the second elongated member, wherein the bridge is integrally formed with each of the first and second elongated members.

5. The instrument support of claim 4, wherein each of the first and second stabilizers is rigid and interposed between the cushion layer and the second outer layer.

6. The instrument support of claim 1, wherein each of the first and second elongated members has a first end and a second end, each first end including an attachment portion for attaching an instrument.

7. The instrument support of claim 1, wherein the bridge includes an extension mechanism, the extension mechanism being configured to vary a distance between the first elongated member and the second elongated member.

8. The instrument support of claim 3, wherein each of the first and second elongated members further includes a rigid bar interposed between the second outer layer and the cushion layer.

9. An instrument support comprising:
first and second elongated members, each of the first and second elongated members including:
a first end and a second end defining a length there-between, and
a protrusion positioned at a point along each of the first and second elongated members between the first and second ends; and
a bridge having a first slot configured to receive the first elongated member and a second slot configured to receive the second elongated member.

10. The instrument support of claim 9, wherein each of the first elongated member, the second elongated member, and the bridge include:
a first outer layer;
a second outer layer; and
a cushion layer interposed between the first outer layer and the second outer layer.

11. The instrument support of claim 10, wherein the bridge further includes first and second stabilizers, the first stabilizer being positioned on a periphery of the first slot, the second stabilizer being positioned on a periphery of the second slot, and each of the first and second stabilizers being rigid and interposed between the cushion layer and the second outer layer of the bridge.

12. The instrument support of claim 10, wherein, a third layer is provided so as to cover the first outer layer, each of the first and second slots being defined between the third layer and the first outer layer.

13. The instrument support of claim 9, wherein the first end of each of the first and second elongated members includes an attachment portion configured to be attached to an instrument.

14. The instrument support of claim 9, wherein the bridge includes an extension mechanism, the extension mechanism being configured to vary a distance between the first elongated member and the second elongated member.

15. The instrument support of claim 9, wherein the first elongated member, the second elongated member, and the bridge are separately formed members.

16. The instrument support of claim 9, wherein the protrusion is positioned along each of the respective first and second elongated members such that, in an assembled configuration, the protrusion abuts the bridge.

17. The instrument support of claim 16, wherein the bridge is adjacent to a center point between the first and second ends of each of the first and second elongated members.

18. The instrument support of claim 9, wherein the first and second slots of the bridge open in elongated directions of the respective first and second elongated members.

19. The instrument support of claim 10, wherein each of the first and second elongated members further includes a rigid bar interposed between the second outer layer and the cushion layer.

20. An instrument support comprising:
first and second elongated members;
a bridge connecting the first elongated member to the second elongated member; and
first and second rigid stabilizers, the first rigid stabilizer being positioned at a connection between the bridge and the first elongated member, the second rigid stabilizer being positioned at a connection between the bridge and the second elongated member.
